(19) United States
(12) Patent Application Publication
(10) Pub. No.: US 2017/0326712 A1
(43) Pub. Date: Nov. 16, 2017

(54) Driving Device And Power Tool Comprising Same

(71) Applicant: Johnson Electric S.A., Murten (CH)

(72) Inventors: Yue LI, Hong Kong (CN); Jing Ning TA, Hong Kong (CN); Bin YU, Shenzhen (CN); Qiu Mei LI, Shenzhen (CN)

(21) Appl. No.: 15/495,198

(22) Filed: Apr. 24, 2017

(30) Foreign Application Priority Data
May 10, 2016 (CN) 2016 1030 8301.X

(51) Int. Cl. B25B 21/02; H02K 1/14; B25F 5/00; F16H 1/28; H02K 9/06; H02K 1/27

(52) U.S. Cl. CPC B25B 21/026; H02K 9/06; H02K 1/2706; B25F 5/008; F16H 1/28; H02K 1/146

(57) ABSTRACT

A driving device includes a motor and a gearbox. The gearbox includes a sun gear, planetary gears surrounding and meshing with the sun gear, and an internal ring gear surrounding and meshing with the planetary gears. The motor is a single phase motor. The sun gear is integrally formed with a rotary shaft of the motor. A power tool is also disclosed which includes the driving device, a rotatable working head driven by the driving device, and a striking unit disposed between the driving device and the working head. By integrating the sun gear and the motor rotary shaft to form an integral gear shaft, the number of the teeth of the sun gear can be reduced to five or less. Therefore, the transmission ratio of the gearbox can be effectively increased without changing the maximum geometric outer diameter.

### CROSS REFERENCE TO RELATED APPLICATIONS

This non-provisional patent application claims priority under 35 U.S.C. §119(a) from Patent Application No. 201610308301.X filed in The People's Republic of China on May 10, 2016.

### FIELD OF THE INVENTION

The present invention relates to the field of driving technology, and in particular to a driving device including a speed reduction mechanism with large gear ratio, and a power tool using the driving device.

### BACKGROUND OF THE INVENTION

Planetary gearboxes are often used to reduce the speed of a motor and then provide a speed-reduced output. A typical planetary gearbox includes a sun gear, an internal ring gear, a plurality of planetary gears, and a carrier driven by the planetary gears. The sun gear and planetary gears are received in the internal ring gear. The planetary gears surround the sun gear, and each planetary gear meshes with both of the sun gear and the internal ring gear. The sun gear is fixedly attached around an output shaft of the motor and rotates along with the output shaft of the motor. Therefore, as the motor operates, the sun gear drives the planetary gears. The planetary gears revolve around the sun gear under the constraint of the internal ring gear, making the carrier rotate. The output shaft of the motor should have an outer diameter sized to be able to bearing a large enough torque. As a result, the sun gear and the internal ring gear both have a large outer diameter, which leads to a large overall volume of the gearbox and limits a gear ratio of the gearbox.

### SUMMARY OF THE INVENTION

Some features and advantages of the present invention are described in the following description, or are obvious from the description, or may be learned through practicing the present invention.

In one aspect, the present invention provides a driving device comprising a single phase motor with a rotary shaft and a gearbox. The gearbox includes a gear integrally formed with the rotary shaft of the motor.

Preferably, a ratio of an outer diameter of the sun gear to an outer diameter of other portions of the rotary shaft is in the range of 0.9 to 1.4.

Preferably, the number of teeth of the sun gear is three to five.

Preferably, the gear is a sun gear and the gearbox further comprises a plurality of planetary gears surrounding and meshing with the sun gear, an internal ring gear surrounding and meshing with the planetary gears.

Preferably, each of the sun gear, the planetary gears and the inner ring gear is a helical gear.

Preferably, the gearbox further comprises a carrier which includes an upper mounting plate and a lower mounting plate that are fixed together, and opposite ends of central axles of the planetary gears are fixed to the upper mounting plate and the lower mounting plate, respectively.

Preferably, the driving device further comprises an output member connected with the carrier for synchronous rotation with the carrier.

Preferably, the driving device further comprises a fan fixedly connected to the rotary shaft and disposed between the motor and the gearbox.

Preferably, the fan comprises a hub attached around the rotary shaft, a plurality of vanes connected with the hub, and a panel connected with the vanes. The panel is substantially perpendicular to the rotary shaft and disposed between the vanes and the gearbox.

Preferably, the motor is an inner-rotor motor capable of bidirectional startup and having an output speed of greater than 20000 rpm. The gearbox has a gear ratio of eight.

In another aspect, the present invention provides a power tool comprising a rotatable working head. The power tool further comprises the driving device described above, and the working head is driven by the gearbox of the driving device.

Preferably, the power tool further comprises a striking unit disposed between the gearbox and the working head. The striking unit is driven by the gearbox to synchronously drive the working head in a first mode, and the striking unit is driven by the gearbox to strikingly drive the working head in a second mode.

Preferably, the striking unit comprises a hollow cylindrical striking member and a compressive spring abutting between the striking member and the carrier of the driving device. The striking member is mounted to an end of an output member of the driving device so as to be driven to rotate by the output member. The compressive spring surrounds the output member.

Preferably, the working head comprises a rotary body and rotary arms extending outwardly from the rotary body; protrusions are formed on an end face of the striking member opposite from the motor. The protrusions engage with the rotary arms to drive the working head.

Preferably, the striking member comprises a mounting hole for mounting to the end of the output member, and concaves are formed in two opposed positions of an inner surface of the mounting hole. Driving blocks are formed on opposite sides of the output member, for extending into the concaves to drive the striking member to rotate.

Preferably, each of the concaves comprises a U-shaped driving device that acts as a sliding groove for a corresponding one of the driving blocks.

The present invention provides a driving device and a power tool using the driving device. By integrally forming the sun gear with the rotary shaft into a monolithic structure, the number of the teeth of the sun gear is reduced, and the transmission ratio of the gearbox of the driving device is increased, such that a single phase motor can be used to reduce cost.

By reading this disclosure, those skilled in the art can better understand the features and contents of the technical solutions.

### BRIEF DESCRIPTION OF THE DRAWINGS

In order to make advantages and implementation of the present invention become more apparent, embodiments of the present invention are described below in detail with reference to the drawings. Contents shown in the drawings are for the purposes of illustration only and should not be regarded as limiting. In the drawings:

FIG. 1 illustrates a driving device according to one embodiment of the present invention.

FIG. 2 illustrates a motor of the driving device of FIG. 1.

FIG. 3 is an exploded view of a gearbox of the driving device of FIG. 1.

FIG. 4 illustrates the gearbox of the driving device of FIG. 1.

FIG. 5 illustrates a power tool according to another embodiment of the present invention.

FIG. 6 is a sectional view of the power tool of FIG. 5.

FIG. 7 and FIG. 8 illustrate a striking unit of the power tool of FIG. 5.

### DETAILED DESCRIPTION OF THE PREFERRED EMBODIMENTS

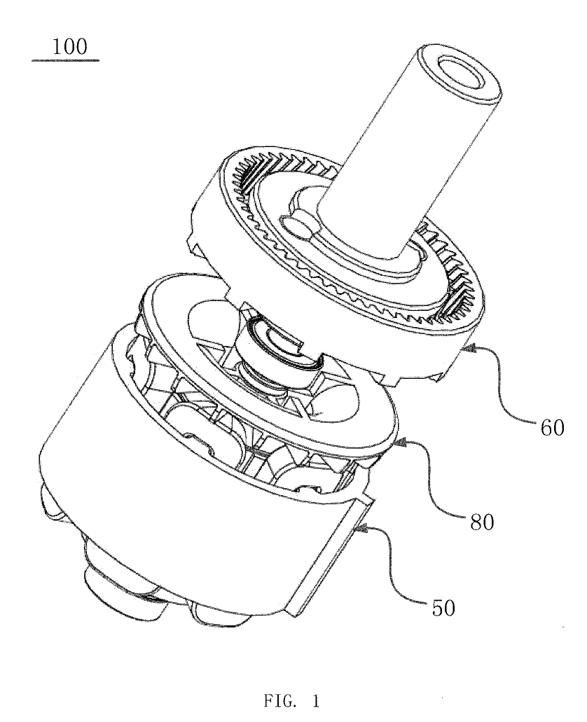

Referring to FIG. 1, a driving device 100 according to the present invention includes a motor 50 and a planetary gearbox 60. The planetary gearbox 60 is mounted to an output end of the motor 50 in order to reduce the output speed of the motor 50 and then provide a speed-reduced output.

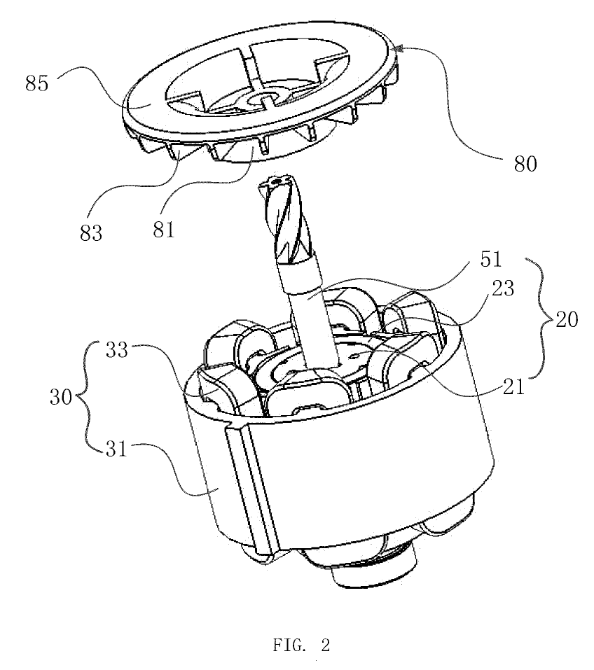

Referring to FIG. 1 and FIG. 2, the motor 50 includes a stator 30 and a rotor 20. The stator 30 includes a stator core 31 made of magnetic conductive material such as iron and windings 33 wound around the stator core 31. The stator core 31 includes an annular yoke and a plurality of stator teeth extending inwardly from the yoke. Winding slots are formed between adjacent stator teeth, and the windings 33 are wound around the stator teeth. The rotor 20 includes a rotary shaft 51, a rotor core 21 fixed to the rotary shaft 51, and a permanent magnet 23 mounted to the rotor core 21. A gap is defined between the magnet 23 and the stator teeth of the stator core 31, thus allowing the rotor 20 to rotate relative to the stator 30. In this embodiment, the motor is a single phase motor and the stator includes six stator teeth, and six windings are wound around the six stator teeth, respectively. The six windings are connected to form a phase. The rotor includes six permanent magnet poles. The motor 50 is of an inner-rotor type, and is capable of bidirectional startup.

In this embodiment, a fan 80 is fixedly mounted to the rotary shaft 51 such that the fan 80 is rotatable with the shaft 51. The fan 80 is disposed between the rotor core 21 and the gearbox 60. The fan 80 includes a hub 81 attached around the rotary shaft 51, a plurality of vanes 83 connected to the hub 81, and a panel 85 connected to the vanes 83. The panel 85 is substantially perpendicular to the rotary shaft 51 and disposed between the vanes 83 and the gearbox 60. As the motor operates, the fan 80 rotates with the rotor to generate airflow blowing toward the stator core 31 and the windings 33. A portion of the airflow may also flow through the gap between the rotor core 23 and the stator core 31, thus achieving rapid heat dissipation for the motor.

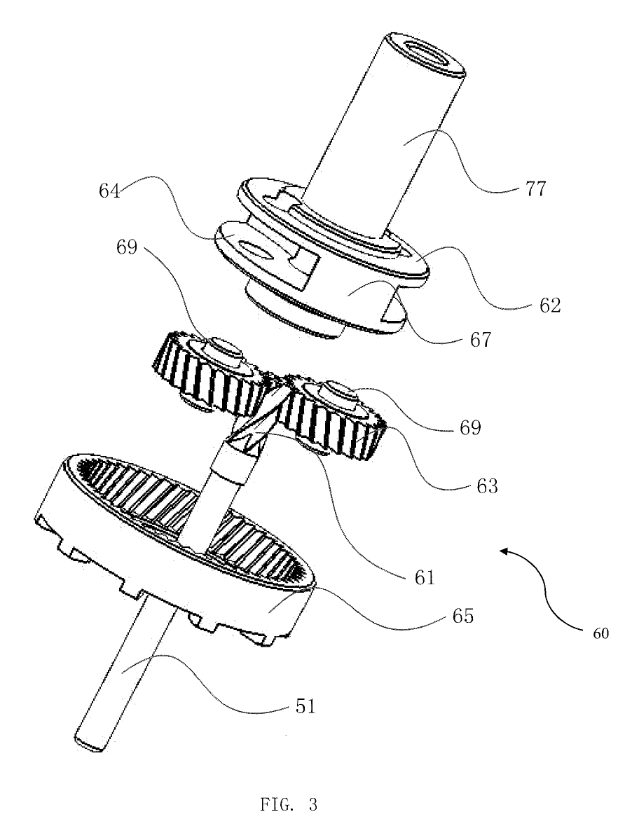

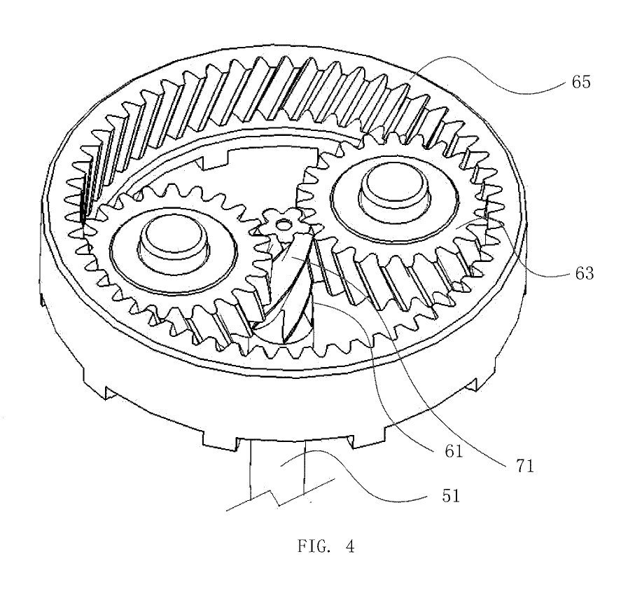

Referring to FIG. 1, FIG. 3 and FIG. 4, the gearbox 60 includes a sun gear 61, a plurality of planetary gears 63 surrounding and meshing with the sun gear 61, and an internal ring gear 65 surrounding the planetary gears 63. The sun gear 61 is integrally formed on the rotary shaft 51 of the motor 50. Therefore, the sun gear 61 integrally formed with the rotary shaft has a greatly reduced outer diameter in comparison with the conventional sun gear that is attached around the rotary shaft. For example, the outer diameter of the sun gear of the present invention may be equal to or slightly greater than the outer diameter of other portions of the rotary shaft 51. A ratio of the outer diameter of the sun gear 61 to the outer diameter of other portions of the rotary shaft may be set to be within 0.9 to 1.4, depending upon actual requirements. Because the present invention can reduce the outer diameter of the sun gear 61, the number of teeth of the sun gear 61 can also be reduced. In this invention, the number of the teeth 71 of the sun gear 61 can be reduced to five or less, for example, three. The transmission ratio of the gearbox can be effectively increased to, for example, above 60%, without changing the maximum geometric outer diameter of the gearbox. On the other hand, as the number of the teeth is reduced, an overlap ratio between the sun gear and the planetary gears is accordingly reduced if the spur gears are still used. Therefore, helical gears are preferably used in this embodiment to increase the overlap ratio between the gears meshing with each other. In particular, the sun gear 61 and the planetary gears 63 may be helical gears, and the teeth of the internal ring gear 65 are also helical teeth. The motor 50 may be a single phase motor. The single phase motor has a large output speed, which is particularly suitable for the speed reduction mechanism with large gear ratio of the present invention. In practice, the output speed of the motor 50 is greater than 20000 rpm, and the gear ratio/gear ratio of the gearbox 60 is greater than 8, preferably, greater than 10. For example, in this embodiment, the gear ratio can be 11 to 12.

The planetary gears 63 mesh with both of the sun gear 61 and the internal ring gear 65, so as to be able to revolve around the sun gear 61 as the rotary shaft 51 rotates. Each planetary gear 63 is pivotably mounted to a carrier 67. Therefore, as the planetary gears 63 revolve around the sun gear 61, the planetary gears 63 drive the carrier 67 to rotate, which in turn drives an output member 77 connected with the carrier 67 to rotate. In this embodiment, the output member 77 is a protruding post. It should be understood that the output member 77 may be in another form.

Referring to FIG. 3, the carrier 67 includes an upper mounting plate 62 and a lower mounting plate 64 that are fixed to each other. Each planetary gear 63 is received between the upper mounting plate 62 and the lower mounting plate 64. Each planetary gear 63 is pivotably mounted to its respective center axle 69. Opposite ends of the center axle 69 are fixed to the upper mounting plate 62 and the lower mounting plate 64, respectively. In the traditional planetary gear, usually only one end of the center axle of the planetary gear is supported by the carrier. However, both ends of the center axle of the planetary gear of this embodiment are supported by the carrier, which enables the center axle to bear larger forces and hence satisfy the requirement of higher transmission ratio.

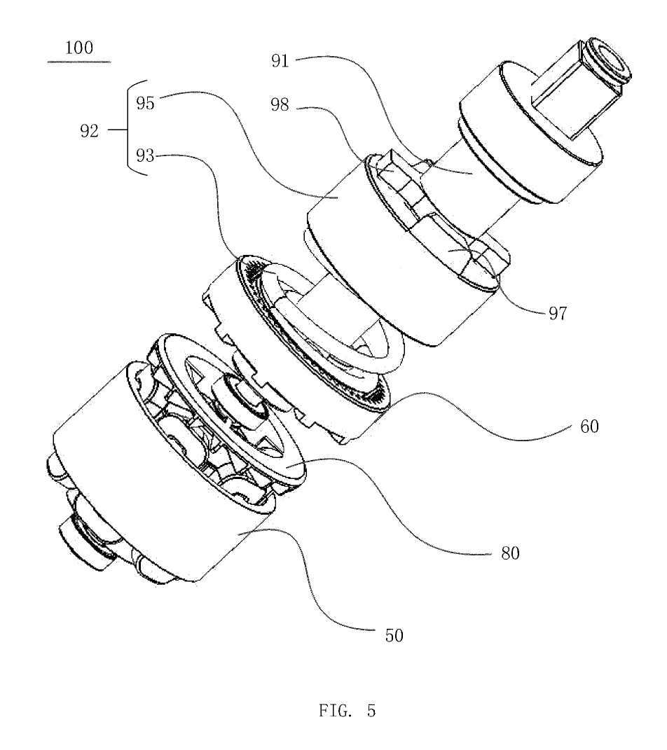

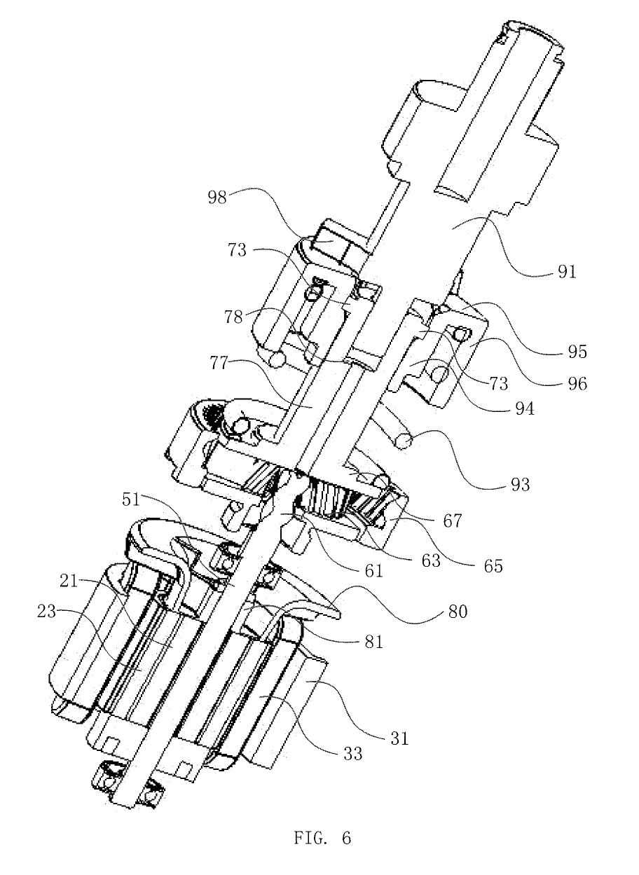

The driving device 100 of the present invention may be used in a power tool, such as an electric drill. FIG. 5 illustrates main components of a power tool according to another embodiment of the present invention. FIG. 5 illustrates a driving device 100, a working head 91 to be driven by the driving device, and a striking unit 92 disposed between the driving device 100 and the working head 91. An inner bore 78 (shown in FIG. 6) is defined in an axial end face of the output member 77 (shown in FIG. 6), which is in loose-fit with or slightly tight-fit with an end of the working head 91. It is noted that the striking unit 92 may not be required but may be optionally selected depending on the specific structure of the working head 91 or actual requirements of the operation.

Referring to FIG. 5 to FIG. 7, the striking unit 92 includes a circular hollow cylindrical striking member 95, and a compressive spring 93 abutting between the striking member 95 and the carrier 67. The compressive spring 93 surrounds the output member 77 of the carrier 67, and the striking member 95 is mounted to an end of the output member 77 so as to be driven by the output member 77. Protrusions 97 are formed on an end face of the striking member 95 opposite from the motor, for driving the working head 91. The working head 91 includes a rotary body and rotary arms 98 extending outwardly from the rotary body. As the striking member 95 rotates, the protrusions 97 drive the rotary arms 98 to thereby drive the working head 91. In this embodiment, the protrusions 97 include two protrusions 97 which are symmetrically arranged, and the rotary arms 98 include two rotary arms 98 which are symmetrically arranged.

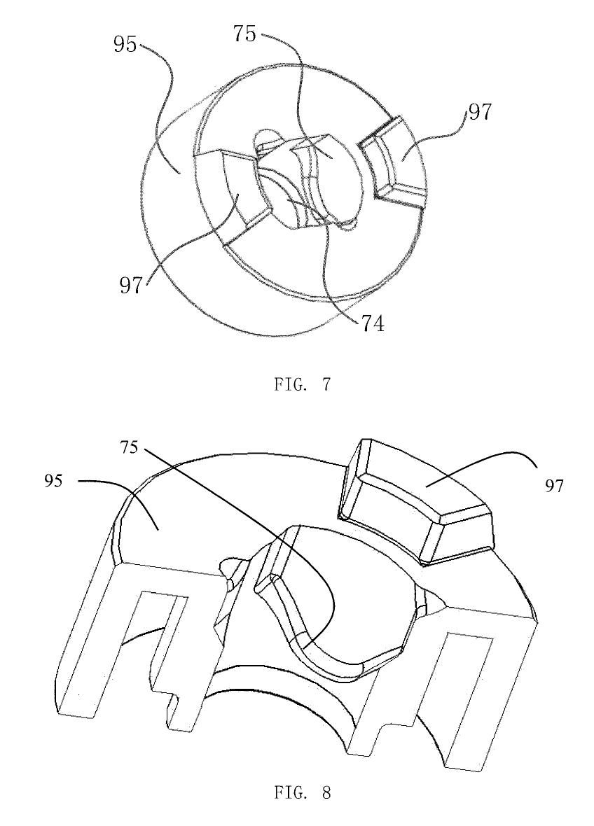

Referring to FIG. 7 and FIG. 8, the striking member 95 includes a mounting hole 74 for mounting to the end of the output member 77 of the carrier 67. Two concaves 75 are formed in two opposite positions of an inner surface of the mounting hole. Driving blocks 73 are formed on opposite sides of the output member 77, which extend into the two concaves 75 so as to drive the striking member 95 to rotate.

Each concave 75 includes a U-shaped bottom adjacent the motor. This U-shaped bottom acts as a sliding groove for the driving block. In a first driving mode, under the resilient pushing of the compressive spring 93, the driving blocks of the output member 77 are disposed at central areas of the U-shaped bottoms of the concaves of the striking member 95, respectively. At this time, when the striking member 95 rotates, its protrusions 97 drive the rotary arms 98 of the working head 91. In case the working head 91 experiences a large resistance, the power tool automatically changes to a striking driving mode. In particular, the working head 91 does not rotate or rotates at a low speed due to the large resistance, which causes the driving blocks 73 to slide from the central areas to sides of the U-shaped bottoms and, therefore, causes the striking member 95 to slide toward the motor (i.e. away from the working head 91), thus disengaging the protrusions 97 of the striking member 95 from the rotary arms 98 of the working head 91. Therefore, the striking member 95 rotates continuously. During continuous rotation of the striking member 95, under the resilient pushing of the compressive spring 93, the driving blocks 73 slide again to the central areas of the U-shaped bottoms of the concaves of the striking member 95, making the protrusions 97 of the striking member 95 contact the rotary arms 98 of the working head 91. The striking member 95 has a greater rotation speed than the working head 91. Therefore, the protrusions 97, when contacting the rotary arms 98 of the working head 91, exert larger striking forces on the rotary arms 98 to drive the working head 91 to rotate.

The present invention provides a driving device and a power tool using the driving device. By integrating the sun gear and the motor rotary shaft to form a monolithic gear shaft, the number of the teeth of the sun gear can be reduced to five or less. Therefore, the transmission/gear ratio of the gearbox can be effectively increased without changing the maximum geometric outer diameter. As the transmission ratio of the driving device is large, the driving device imposes a lower requirement to the motor torque and a higher requirement to the motor speed. Therefore, a single phase motor can be used to simplify the structure of the driving device and reduce cost.

The power tool may be an electric screwdriver or an electric drill.

The preferred embodiments of the present invention have been described with reference to the drawings. Various modifications may be made without departing from the spirit and scope of the present invention. For example, some features shown or described in one embodiment may be applied to another embodiment to obtain a further embodiment. The above descriptions are merely the preferred embodiments of the present invention and shall not be used to limit the scope of the present invention. Any equivalents made in accordance with the disclosure of the specification and drawings shall also fall within the scope of the present invention.

1. A driving device comprising:
a single phase motor with a rotary shaft; and
a gearbox comprising a gear, wherein the gear is integrally formed with the rotary shaft.

2. The driving device of claim 1, wherein a ratio of an outer diameter of the gear to an outer diameter of other portions of the rotary shaft is in the range of 0.9 to 1.4.

3. The driving device of claim 1, wherein the number of teeth of the gear is three to five.

4. The driving device of claim 1, wherein the gear is a sun gear, and the gearbox further comprises a plurality of planetary gears surrounding and meshing with the sun gear, and an internal ring gear surrounding and meshing with the planetary gears.

5. The driving device of claim 4, wherein the gearbox further comprises a carrier for mounting of the planetary gears, the carrier includes an upper mounting plate and a lower mounting plate that are fixed together, and opposite ends of central axles of the planetary gears are fixed to the upper mounting plate and the lower mounting plate, respectively.

6. The driving device of claim 5, further comprising an output member connected with the carrier for synchronous rotation with the carrier.

7. The driving device of claim 4, wherein each of the sun gear, the planetary gears and the inner ring gear is a helical gear.

8. The driving device of claim 1, further comprising a fan secured to the rotary shaft and disposed between the motor and the gearbox.

9. The driving device of claim 8, wherein the fan comprises a hub attached around the rotary shaft, a plurality of vanes connected with the hub, and a panel connected with the vanes, and the panel is substantially perpendicular to the rotary shaft and disposed between the vanes and the gearbox.

10. The driving device of claim 1, wherein the motor is an inner-rotor motor capable of bidirectional startup and having an output speed of greater than 20000 rpm, and the gearbox has a gear ratio of greater than eight.

11. A power tool comprising:
a driving device comprising:
a single phase motor with a rotary shaft; and
a gearbox comprising a gear integrally formed with the rotary shaft; and
a rotatable working head driven by the gearbox of the driving device.

12. The power tool of claim 11, further comprising a striking unit disposed between the gearbox and the working head, the striking unit is driven by the gearbox to synchronously drive the working head in a first mode, and the striking unit is driven by the gearbox to strikingly drive the working head in a second mode.

13. The power tool of claim 12, wherein the striking unit comprises a hollow cylindrical striking member and a compressive spring compressed between the striking member and the carrier of the driving device, the striking member is mounted to an end of an output member of the driving device so as to be driven to rotate by the output member, and the compressive spring surrounds the output member.

14. The power tool of claim 13, wherein the working head comprises a rotary body and rotary arms extending outwardly from the rotary body, and protrusions are formed on an end face of the striking member opposite from the motor for engaging with the rotary arms to drive the working head.

15. The power tool of claim 13, wherein the striking member comprises a mounting hole for mounting to the end of the output member, and concaves are formed in two opposed positions of an inner surface of the mounting hole, driving blocks are formed on opposite sides of the output member, for extending into the concaves to drive the striking member to rotate.

16. The power tool of claim 15, wherein each of the concaves comprises a U-shaped bottom that acts as a sliding groove for a corresponding one of the driving blocks.

17. The power tool of claim 11, wherein the gear is a sun gear, and the gearbox further comprises a plurality of planetary gears surrounding and meshing with the sun gear, and an internal ring gear surrounding and meshing with the planetary gears.
